(19) United States
(12) Patent Application Publication
(10) Pub. No.: US 2014/0082334 A1
(43) Pub. Date: Mar. 20, 2014

(54) Encoding to Increase Instruction Set Density

(71) Applicants: Steven R. King, Portland, OR (US); Sergey Kochuguev, Saint-Petersburg (RU); Alexander Redkin, Saint-Petersburg (RU); Srihari Makineni, Portland, OR (US)

(72) Inventors: Steven R. King, Portland, OR (US); Sergey Kochuguev, Saint-Petersburg (RU); Alexander Redkin, Saint-Petersburg (RU); Srihari Makineni, Portland, OR (US)

(21) Appl. No.: 13/992,722

(22) PCT Filed: Dec. 30, 2011
(86) PCT No.: PCT/US11/68020

§ 371 Date: Oct. 25, 2013

(51) Int. Cl. G06F 9/30

(52) U.S. Cl. CPC G06F 9/30181
USPC 712/226

(57) ABSTRACT

A conventional instruction set architecture such, as the x86 instruction set architecture, may be reencoded to reduce the amount of memory used by the instructions. This may be particularly useful in applications that are memory sized limited, as is the case with microcontrollers. With a reencoded instruction set that is more dense, more functions can be implemented or a smaller memory size may be used. The encoded instructions are then naturally decoded at run time in the predecoder and decoder of the core pipeline.

### BACKGROUND

This relates generally to computer processing and particularly to instruction set architectures.

An instruction set is a set of machine instructions that a processor recognizes and executes. There are a variety of known instruction set architectures including the x86 instruction set architecture developed by Intel Corporation. The instruction set includes a collection of instructions supported by a processor including arithmetic, Boolean, shift, comparison, memory, control flow, peripheral access, conversion and system operations. An instruction set architecture includes the instruction set, a register file, memory and operation modes. The register file includes programmer accessible storage. The memory is the logical organization of the memory. The operating modes includes subsets of instructions that are privileged based on being in a particular mode.

The term x86 refers to Intel® processors released after the original 8086 processor. These include the 286, 386, 486 and Pentium processors. If a computer's technical specifications state that is based on the x86 architecture, that means it uses an Intel processor. Since Intel's x86 processors are backwards compatible, newer x86 processors can run all the programs that older processors could run. However, older processors may not be able to run software that has been optimized for newer x86 processors.

A compiler is a program that translates source code of a program written in a high-level language into object code prior to execution of the program. Thus the compiler takes a source code program and translates it into a series of instructions using an instruction set architecture. A processor then decodes these instructions and executes the decoded instructions.

### BRIEF DESCRIPTION OF THE DRAWINGS

Some embodiments are described with respect to the following figures:

FIG. 1 is a schematic depiction of one embodiment to the present invention;

FIG. 2 is a flow chart for the reencoding in accordance with one embodiment to the present invention; and

FIG. 3 is a depiction of a processor pipeline according to one embodiment.

### DETAILED DESCRIPTION

A conventional instruction set architecture, such as the x86 instruction set architecture, may be reencoded to reduce the amount of memory used by the instructions. This may be particularly useful in applications that are memory size limited, as is the case with microcontrollers. With a reencoded instruction set that is more dense, more functions can be implemented or a smaller memory size may be used. The encoded instructions are then naturally decoded at run time in the predecoder and decoder of the core pipeline.

In accordance with some embodiments, the size of an instruction is reduced and then the core reads the instruction at run time. The core moves the instruction from stage to stage, expanding the instruction in the pipeline (which does not use any external memory). Eventually the core recognizes and handles the instructions.

In some embodiments, a reduced instruction set architecture may also be used. In a reduced instruction set architecture (which is different than a more dense instruction set architecture), instructions that are generally not used and instructions needed only for backwards compatibility may simply be removed. This reduced instruction set reduces the variety of instructions rather than their density.

With reencoding to form more dense instruction sets, the idea is not to remove instructions but rather to compress instructions using heuristics to control the amount of compression.

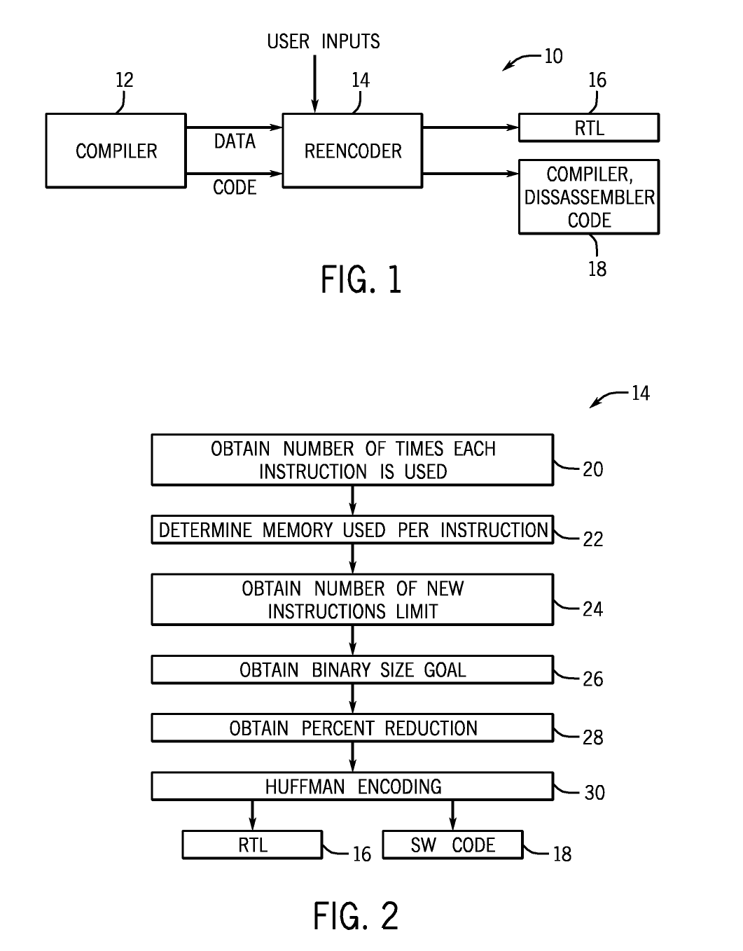

Thus, referring to FIG. 1, a compiler 12 compiles input code and produces compiled code and data to reencoder 14. The data may include information about the compiled code such as symbolic names used in the source and information describing how one compiled function references another compiled function.

The reencoder may also receive user inputs specifying the number of new instructions that are permissible for a particular case. The user may also specify a binary size goal. For example a user may have a certain amount of memory in a given product and the user may want to limit the binary size of the instruction set to fit within that available memory. Also the user may indicate a maximum percent reduction or compression.

A reason for specifying these inputs is that generally the more compressed the instructions, the more difficult it may be to decode them, and the more focused the instructions may be for one particular use which may make the dense instructions less useful in other applications. Thus the reencoder receives data from the compiler about the compilation process as well as user inputs and uses that information to reencode the instruction set using Huffman encoding. The amount of Huffman encoding may be controlled by the user inputs.

From the input binaries and the user inputs, the reencoder may also determine new instructions. These new instructions may reduce binary size by more efficient encoding of operands than x86 instructions. These more efficient encodings, relative to x86 encoding, may include but are not limited to reduced size encoding, implied operand values, multiplication of an operand by an implied scale factor, addition to an operand of an implied operand offset value, unsigned or signed extension of operands to larger effective widths, and others.

As is well-known, Huffman codes of a set of symbols are generated based at least in part on the probability of occurrence of source symbols. A sorted tree, commonly referred to as a “Huffman tree” is generated to extract the binary code and the code length. See, for example, D. A. Huffmann, “A Method for the Construction of Minimum-Redundancy Codes,” proceedings of the IRE, Volume 40 No. 9, pages 1098 to 1101, 1952. D. A. Huffman, in the aforementioned paper describes the process this way:

List all possible symbols with their probabilities;

Find the two symbols with the smallest probabilities;

Replace these by a single set containing both symbols,

whose probability is the sum of the individual probabilities; and

Repeat until the list contains only one member.

This procedure produces a recursively structured set of sets, each of which contains exactly two members. It, therefore, may be represented as a binary tree (“Huffman Tree”) with the symbols as the “leaves.” Then to form the code (“Huffman Code”) for any particular symbol: traverse the binary tree from the root to that symbol, recording “0” for a left branch and “1” for a right branch.

The reencoder may modify the Huffman encoding process to allow for byte-wise encoding rather than binary encoding. Byte-wise Huffman encoding results in encoded values that are always a multiple of 8-bits in length. The byte wise encoding modifies the Huffman encoding process by using a N-ary tree, rather than a binary tree, where ‘N’ is 256 and thus each node in the tree may have 0-255 child nodes.

The reencoder may further modify the resulting Huffman encoded values to provide for more efficient representation in hardware logic or software algorithms. These modifications may include grouping instructions with similar properties to use numerically similar encoded values. These modifications may or may not alter the length of the original Huffman encoding.

The reencoder may reserve ranges of encoded values for special case use or for later expansion of the instruction set. The reencoder may apply a new more compact opcode to one or more specific instructions without using Huffman encoding.

Then in some embodiments the reencoder 14 outputs the register transfer logic (RTL) 16 for a redesigned predecoder and decoder as necessary to execute the more dense instructions as indicated at block 16. In some embodiments, the encoder also may provide new software code for the compiler and disassembler as indicated at 18.

The operation of the reencoder is illustrated in the sequence shown in FIG. 2. The sequence may be implemented in software, firmware and/or hardware. In software and firmware embodiments it may be implemented by processor executed instructions stored in a non-transitory computer readable medium such as an optical, magnetic or semiconductor storage.

The sequence begins by obtaining the number of times each of the instructions was used in the compiler 12 as indicated in block 20. This information may be obtained by the reencoder 14 from the compiler 12 or calculated by the reencoder by inspecting the output from the compiler 12. The reencoder 14 may also determine how much memory is used for each instruction as indicated in block 22. This information is useful in determining the amount of reencoding that is desirable. Instructions that are used a lot or instructions that use a lot of memory are the ones that need to be encoded the most. Because they are used more often, they have a bigger impact on required memory size. Thus these oft used instructions may get reencoded more compactly compared to instructions that are used less often.

Next, the flow obtains a number of new instructions limit from the user as indicated in block 24. The user may specify the number of new instructions that are allowable. A new instruction may be provided to replace a conventional instruction set of architecture instruction. These new instructions may have other effects, including making the encoded instructions that are architectural less applicable to other uses.

The reencoder also obtains the binary size goal of the user as indicated in block 26. The binary size specifies the amount of memory that the design has allocated for instruction storage.

The reencoder also obtains from user input a number of reserved instruction slots to allocate. These reserved slots may be used by the user for future extensions to the instruction set.

Finally the sequence obtains a percent reduction goal as indicated in block 28. After a certain percent reduction, the returns tend to be diminishing and therefore the user may specify how much reduction of the code is desirable.

Then all of this information is used, in some embodiments, to control the Huffman reencoding in block 30. Those instructions that are used more often are encoded more and those instructions that are used less are encoded less. The number of new instructions that are permissible limits the amount of reencoding that can be done. The binary size sets a stop point for the reencoding. Until the binary size goal is reached, the Huffman reencoding must continue to reencode the instructions. Finally, once the binary size is reached, Huffman reencoding continues until it reaches the reduction percentage limit that was set.

Then the Huffman reencoding stage 30 may, in some embodiments, output the register transfer logic 16 to implement the encoded instructions. Typically this means that code is provided for units of the predecoder and decoder and the core pipeline. The Huffman reencoding stage 30 may also output software code 18 for the compiler and disassembler to implement the reencoded instruction set.

Then the user tests and deploys the new reencoded binary on the newly designed core. New code development continues using the reencoded instruction set architecture.

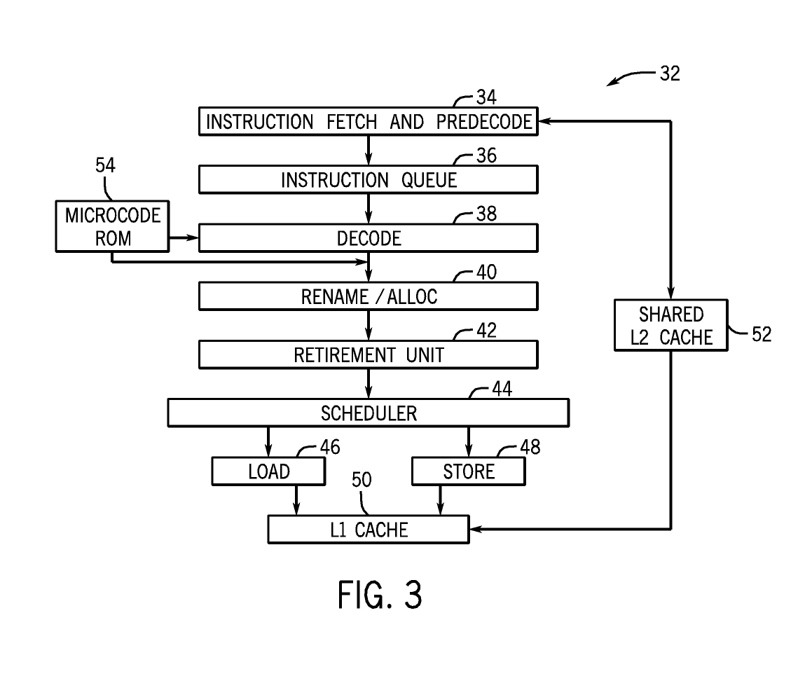

Referring to FIG. 3, a processor pipeline 32, in one embodiment, includes an instruction fetch and predecode stage 34 coupled to an instruction queue 36 and then a decode stage 38. Connected to the instruction decode stage 38 is a rename/allocate stage 40. A retirement unit 42 is coupled to a scheduler 44. The scheduler feeds load 46 and store 48. An Level 1 (L1) cache 50 is coupled to a shared Level 2 (L2) cache 52. A microcode read only memory (ROM) 54 is coupled to the decode stage.

The fetch/predecode stage 34 reads a stream of instructions from the L2 instruction cache memory. Those instructions may be decoded into a series of microoperations. Microoperations are primitive instructions executed by processor parallel execution units. The stream of microoperations, still ordered as in the original instruction stream, is then sent to an instruction pool.

The instruction fetch fetches one cache line in each clock cycle from the instruction cache memory. The instruction fetch unit computes the instruction pointer, based on inputs from a branch target buffer, the exception/interrupt status, and branch-prediction indication from the integer execution units.

The instruction decoder contains three parallel instruction decoders. Each decoder converts an instruction into one or more triadic microoperations, with two logical sources and one logical destination. Instruction decoders also handle the decoding of instruction prefixes and looping operations.

The instruction decode stage 38, instruction fetch 34 and execution stages are all responsible for resolving and repairing branches. Unconditional branches using immediate number operands are resolved and/or fixed in the instruction decode unit. Conditional branches using immediate number operands are resolved or fixed in the operand fetch unit and the rest of the branches are handled in the execution stage.

In some embodiments, the decoder may be larger than a decoder used by processors with less dense instruction set architectures. The decoder has been specifically redesigned as described above to accommodate the compressed instruction set architecture. This means that both the decoder itself and the predecoder may be redesigned to use an instruction set architecture that occupies loss memory area outside the processor itself. The decoder may also have different software customized to handle the different instruction set architecture.

In some embodiments an optimally dense new instruction set architecture encoding may be achieved within user guided constraints. The user can choose more aggressive Huffman reencoding for maximum density, reencoding using a fixed number of new instructions encodings, reencoding assuming small physical address space, or any combination of these.

The user may choose to forego Huffman encoding and utilize only new instructions with more efficient operand handling as identified by the reencoder.

In some embodiments, problem points in an existing instruction set architecture may be solved allowing a smooth continuum of options for adding new, size optimized instructions to instruction set architecture subset. These new instructions may preserve the schematics of the established processor set architecture while providing a more compact binary representation.

A workload optimizing encoding allows more instructions to fit in the same quantity of cache, increasing system performance and decreasing power consumption with improved cache hit ratios in some embodiments.

Reducing the binary size can provide improved power consumption and improve performance in specific applications.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
compressing an instruction set for a processor.

2. The method of claim 1 including compressing instructions using Huffman coding.

3. The method of claim 1 including controlling compression based on a user input.

4. The method of claim 3 including controlling compression based on a user input about the number of new instructions.

5. The method of claim 3 including controlling compression based on a user input about the maximum compression.

6. The method of claim 3 including controlling compression based on a user input about a binary size goal.

7. The method of claim 3 including allow for some reserved instructions of a specified length based on user input.

8. The method of claim 1 including collecting information from a compiler and using that information to control compression.

9. The method of claim 8 including calculating information from the compiler about how many times an instruction was used to control compression.

10. The method of claim 8 including calculating information from the computer about an amount of memory used by an instruction.

11. The method of claim 1 including compressing more frequently used instructions more than less frequently used instructions.

12. The method of claim 1 including identifying new instructions with more efficient operand encoding.

13. The method of claim 1 including identifying new compact opcodes for instructions without using Huffman encoding.

14. A non-transitory computer readable medium storing instructions to enable a processor to implement a method comprising:
compressing an instruction set.

15. The medium of claim 14 including compressing instructions using Huffman coding.

16. The medium of claim 14 including controlling compression based on a user input.

17. The medium of claim 16 including controlling compression based on a user input about the number of new instructions.

18. The medium of claim 16 including controlling compression based on a user input about the maximum compression.

19. The medium of claim 17 including using information from the compiler about how many times an instruction was used to control compression.

20. The medium of claim 17 including using information from the computer about an amount of memory used by an instruction.

21. An apparatus comprising:
a processor; and
an encoder to compress an instruction set for the processor.

22. The apparatus of claim 21, said encoder to compress instructions using Huffman coding.

23. The apparatus of claim 21, said encoder to control compression based on a user input.

24. The apparatus of claim 23, said encoder to control compression based on a user input about the number of new instructions.

25. The apparatus of claim 23, said encoder to control compression based on a user input about the maximum compression.

26. The apparatus of claim 23, said encoder to control compression based on a user input about a binary size goal.

27. The apparatus of claim 21, said encoder to collect information from a compiler and using that information to control compression.

28. The apparatus of claim 27, said encoder to use information from the compiler about how many times an instruction was used to control compression.

29. The apparatus of claim 27, said encoder to use information from the computer about an amount of memory used by an instruction.

30. The apparatus of claim 21, said encoder to compress more frequently used instructions more than less frequently used instructions.
